(19) United States
(12) Patent Application Publication
(10) Pub. No.: US 2026/0106673 A1
(43) Pub. Date: Apr. 16, 2026

(54) COHERENT OPTICAL RECEIVING METHOD AND RECEIVER

(71) Applicant: UIF (University Industry Foundation), Yonsei University, Seoul (KR)

(72) Inventors: Sang-Kook HAN, Seoul (KR); Young-Jin HYUN, Seoul (KR); Hyemin PARK, Seoul (KR); Jinwoo PARK, Seoul (KR); Joungmoon LEE, Seoul (KR)

(21) Appl. No.: 19/360,618

(22) Filed: Oct. 16, 2025

(30) Foreign Application Priority Data
Oct. 16, 2024 (KR) 10-2024-0141540

(51) Int. Cl. H04B 10/61; H04B 10/118

(52) U.S. Cl. CPC H04B 10/612; H04B 10/118; H04B 10/613; H04B 10/6164; H04B 10/65

(57) ABSTRACT

The present disclosure provides a coherent optical receiving method and receiver capable of detecting an optical signal transmitted at a high transmission rate while having low complexity and bit error rate, the coherent optical receiving method comprising the steps of: receiving a transmission optical signal that is transmitted by being offset QAM modulated so that an I signal and a Q signal from a transmitter have a delay time difference equal to an offset time as a reception optical signal; generating a local optical signal having a frequency difference within a bandwidth range from the transmission optical signal by a local oscillator; obtaining a beating optical signal by beating the reception optical signal and the local optical signal; receiving the beating optical signal by a balanced photo detector to obtain a reception signal; and restoring data transmitted by the transmitter from the reception signal.

### CROSS-REFERENCE TO RELATED APPLICATIONS

This application claims priority under 35 U.S.C. § 119 (a) to Korean Patent Application No. 10-2024-0141540, filed on Oct. 16, 2024, with the Korean Intellectual Property Office, the disclosure of which is incorporated herein in its entirety by reference.

### BACKGROUND

### 1. Technical Field

The present disclosure relates to an optical receiving method and receiver, and more particularly, to a coherent optical receiving method and receiver.

### 2. Description of the Related Art

Existing satellite communications have developed mainly based on wide-range Radio Frequency (hereinafter, RF) communications based on geostationary orbit (hereinafter, GEO) satellites. However, recently, low-Earth Orbit (hereinafter, LEO)-based satellite communication has been attracting attention due to problems such as high delay time and spatial attenuation due to long distances in existing GEO-based satellite communication.

LEO satellite communications, which utilizes satellites in low-Earth orbits between approximately 500 and 1,200 km, can overcome delay time and spatial attenuation issues with ground stations, potentially enabling high data transmission rates. However, unlike GEO, LEO satellites' relative positions to ground stations constantly change, necessitating the construction of a satellite communications network using a larger number of satellites. Recently, thousands of satellites have been launched to build LEO satellite networks. Here, Intersatellite Links (ISL) are emerging as a key technology for satellite network construction. In particular, as the number of satellites increases, mutual interference of satellite signals can cause catastrophic damage to satellites on existing missions. Therefore, optical communications-based intersatellite communications (Optical Intersatellite Link: hereinafter, OISLs) are being developed and commercialized, offering advantages over existing RF-based communications, such as lower interference, wider bandwidth, and smaller size. In addition, optical communication has the advantages described above compared to RF, and is attracting attention in areas such as satellite relay system (data relay systems: hereinafter, DRS) that perform communication between ground communication stations and satellites, communication between LEO and GEO satellites, and deep space communication (hereinafter, DSC), and has actually been demonstrated by several countries.

However, high spatial attenuation due to long distances causes serious signal degradation, and it remains an issue that must be overcome for higher data rates. OISL targets long-distance transmission of 500 to 5,000 km, DRS of 36,000 km, and DSC of over 100,000 km. Since OISL and DRS require data rates of at least Gbps, spatial attenuation proportional to the square of the distance is one of the biggest problems that current satellite optical communications must overcome. To solve this problem and transmit high data rates, satellite optical communication using Coherent Detection (hereinafter, CD) method has been developed. CD method has a higher data rate and lower bit error rate performance compared to the existing Direct Detection (DD) method. However, CD method has higher complexity than DD method. Therefore, a new modulation/demodulation technique that can achieve high transmission rates and low bit error rates with less complexity is needed.

### SUMMARY

An object of the present disclosure is to provide a coherent optical receiving method and receiver capable of detecting an optical signal transmitted at a high transmission rate while having low complexity and bit error rate.

Another object of the present disclosure is to provide a coherent optical receiving method and receiver having low signal power loss and bit error rate by receiving a transmitted transmission optical signal synthesized by I/Q signals having an offset time difference corresponding to half of a symbol period, generating a local optical signal having a frequency difference equal to the Nyquist frequency from the transmission optical signal, and beating with the received reception optical signal.

According to one embodiment of the present disclosure, a coherent optical receiving method comprises the steps of: receiving a transmission optical signal that is transmitted by being offset QAM modulated so that an I signal and a Q signal from a transmitter have a delay time difference equal to an offset time as a reception optical signal; generating a local optical signal having a frequency difference within a bandwidth range from the transmission optical signal by a local oscillator; obtaining a beating optical signal by beating the reception optical signal and the local optical signal; receiving the beating optical signal by a balanced photo detector to obtain a reception signal; and restoring data transmitted by the transmitter from the reception signal.

The local optical signal may be generated to have a frequency difference equal to a minimum Nyquist frequency compared to the frequency of the transmission optical signal.

The step of restoring data may include detecting the intensity of the reception signal when the phase of the reception signal determined by time and the Nyquist angular frequency representing the difference between the optical angular frequency of the local optical signal and the optical angular frequency of the reception optical signal is 0, π/2, π, and 3π/2, and obtaining the I value and Q value for two consecutive symbols, and restoring the data from the obtained I value and Q value.

The step of restoring data may include obtaining the I value and Q value of the first symbol among the two symbols from the detected intensity of the reception signal when the phase of the reception signal is 0 and π/2.

The step of restoring data may include obtaining the I value and Q value of the second symbol among the two symbols by inverting the sign of the detected intensity of the reception signal when the phase of the reception signal is π and 3π/2.

The transmission optical signal may be generated by delaying one of the two split lights generated and split from a light source by half a time of a symbol period corresponding to the offset time, modulating the intensity of each of the two split lights according to the I component and Q component of the symbol, and then combining the lights after delaying the phase of the light modulated according to the Q component by π/2.

The offset time may be set to half the symbol period.

According to another embodiment of the present disclosure, a coherent optical receiver includes: a local oscillator for generating a local optical signal having a frequency difference within a bandwidth range from a transmission optical signal transmitted by a transmitter by offset QAM modulating so that an I signal and a Q signal have a delay time difference equal to an offset time; an optical coupler for obtaining a beating optical signal by beating the local optical signal with a reception optical signal which is the transmission optical signal received; and a balanced photo detector for obtaining a reception signal by receiving the beating optical signal.

The coherent optical receiving method and receiver of the present disclosure can transmit a transmission optical signal by synthesizing I/Q signals having an offset time difference corresponding to half of a symbol period, and generate a local optical signal having a frequency difference equal to the Nyquist frequency from the transmission optical signal and beat it with the received reception optical signal, thereby detecting an optical signal transmitted at a high transmission rate while having low complexity and bit error rate.

### BRIEF DESCRIPTION OF THE DRAWINGS

FIG. 1 is a schematic diagram illustrating a coherent optical communication system according to one embodiment.

FIG. 2 is a drawing for explaining the operation method of the coherent optical communication system of FIG. 1.

FIG. 3 is a drawing for explaining a signal detected by the balanced photo detector of FIG. 1.

FIG. 4 illustrates a transmitting and receiving method of a coherent optical communication system according to one embodiment.

### DETAILED DESCRIPTION OF THE INVENTION

Hereinafter, specific embodiments according to embodiments of the present disclosure will be described with reference to the drawings. The following detailed description is provided to assist in a comprehensive understanding of the methods, apparatus and/or systems described herein. However, this is only an example, and the present disclosure is not limited thereto.

In describing the embodiments, when it is determined that detailed descriptions of known technologies related to the present disclosure may unnecessarily obscure the gist of the disclosed embodiments, detailed descriptions thereof will be omitted. In addition, terms used below are defined in consideration of functions in the present disclosure, which may vary depending on the customary practice or the intention of users or operators. Therefore, the definition should be made based on the contents throughout this specification. The terms used in the detailed description are only for describing embodiments, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, parts or combinations thereof, other than those described. In addition, terms such as “unit”, “device”, “module”, “block”, and the like described in the specification refer to units for processing at least one function or operation, which may be implemented by hardware, software, or a combination of hardware and software.

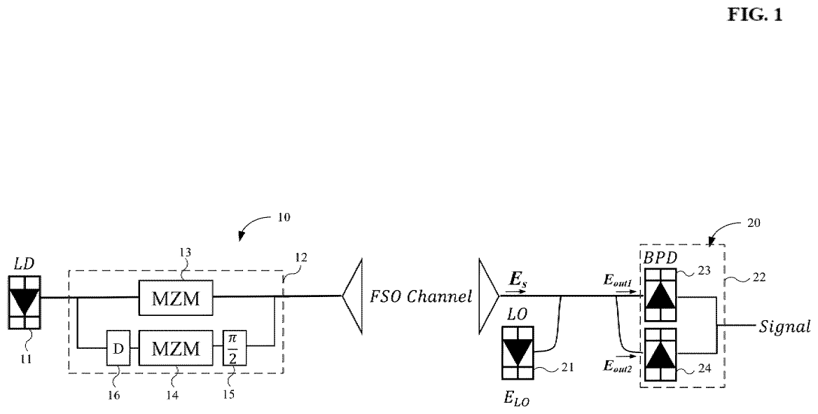

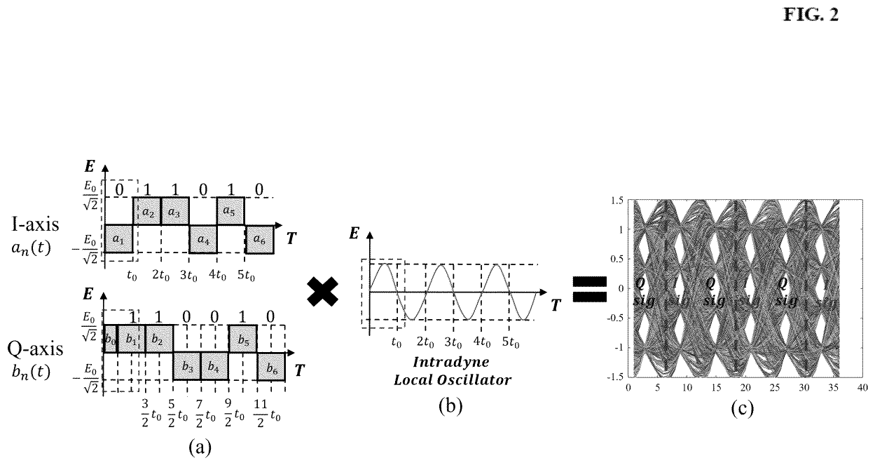

FIG. 1 is a schematic diagram illustrating a coherent optical communication system according to one embodiment, and FIG. 2 is a drawing for explaining the operation method of the coherent optical communication system of FIG. 1.

A coherent optical communication system of one embodiment includes a transmitter 10 and a receiver 20. Here, it is assumed that the optical communication system is a system for satellite communication, and thus the transmitter 10 and receiver 20 may be respectively equipped on different satellites.

Referring to FIG. 1, the transmitter 10 may include a light source 11 and a modulation module 12.

The light source 11 generates and emits light of a specified wavelength and waveform. For example, the light source 11 may generate and emit light in continuous wave mode, and may be implemented using a laser diode (LD), etc.

The modulation module 12 receives and modulates light emitted from the light source 11 to generate a transmission optical signal. The modulation module 12 modulates and outputs the received light according to a control signal generated based on symbols obtained by precoding the data to be transmitted. In particular, in a coherent optical communication system, the modulation module 12 distinguishes and modulates light according to each of the I (In-phase) and Q (Quadrature-phase) components of the symbol, thereby generating the transmission optical signal.

Since the modulation module 12 modulates light by distinguishing it according to each of the I/Q components of the symbol, the modulation module 12 may be divided into a first modulation module that modulates light according to the I component and a second modulation module that modulates light according to the Q component. That is, the first and second modulation modules independently modulate and output the received light.

As illustrated in FIG. 1, the first modulation module may include a first modulator 13, and the second modulation module may include a second modulator 14, a phase controller 15, and a delay unit 16. The first and second modulators 13 and 14 each receive light, modulate its intensity, and output it, and may be implemented using, for example, a Mach-Zehnder Modulator (MZM), which is a representative external optical intensity modulator.

The phase controller 15 receives the intensity-modulated optical signal from the second modulator 14 and delays the phase by 90 degrees (π/2). The phase controller 15 adjusts the phases of the two optical signals, independently intensity-modulated by the two modulators 13 and 14, so that they are orthogonal to each other. Here, the optical signal that is intensity-modulated and not phase-delayed may be referred to as the I signal, and the signal that is phase-delayed by 90 degrees may be referred to as the Q signal.

The delay unit 16 receives one of the two lights emitted and split from the light source 11, delays it by a specified amount of time, and transmits it to the second modulator 14. Here, the delay unit 16 delays the received light by a specified offset time and transmits it to the second modulator 14. In one embodiment, the delay unit 16 may output the signal by delaying it by half (t₀/2) of the symbol period (t₀).

That is, the second modulation module delays the received light by a half symbol period (t₀/2), modulates, and then adjusts the phase to output a Q signal.

While the first modulation module simply modulates the intensity of the received light to output an I signal, the second modulation module delays the light by a half symbol period (t₀/2) and modulates the intensity to output a Q signal, so that the I signal and the Q signal are generated with a time difference of a half symbol period (t₀/2), as shown in (a) of FIG. 2.

Here, as an example, it is assumed that the delay unit 16 is provided in the second modulation module so that the Q signal is delayed by a half symbol period (t₀/2), but the delay unit 16 may also be provided in the first modulation module so that the I signal is delayed.

Meanwhile, although not illustrated for convenience of explanation, the modulation module 12 may further include two optical couplers (not shown). Of the two optical couplers, the first optical coupler receives light emitted from the light source 11, splits it into two lights, and applies them to the first and second modulation modules, while the remaining second optical coupler receives the I signal output from the first modulation module and the Q signal output from the second modulation module, and combines them to generate a transmission optical signal.

In general, a transmitter 10 of a coherent optical communication system generates a transmission optical signal by making the I signal and the Q signal have only a phase difference of 90 degrees (π/2), but in an optical communication system of one embodiment, the transmitter outputs the I signal and the Q signal by making the first modulation module and the second modulation module have not only a phase difference of 90 degrees (π/2) but also an offset time difference, as shown in FIG. 2, thereby generating a transmission optical signal. Here, the offset time is set to a half symbol period (t₀/2) as described above.

Here, the transmitter 10 generates a transmission optical signal using I and Q signals that differ by a half symbol period (t₀/2), which is the offset time, to enable the receiver 20, described below, to detect both the I and Q signals with a simple configuration. In particular, this is to enable the receiver 20 to detect both the I and Q signals with a single Balanced Photo Detector (BPD).

Since the transmitter 10 performs modulation according to each of the I and Q components of the symbol using two modulators (MZMs), generating I and Q signals with a 90-degree phase difference, the transmitter 10 basically performs modulation using the Optical Quadrature Amplitude Modulation (QAM) technique. However, in this case, the transmitter 10 delays one of the I and Q signals by an offset time to have a delay time difference, so the transmitter 10 can be seen as performing Offset-QAM modulation (OQAM).

The transmission optical signal generated by the OQAM technique in the transmitter 10 is transmitted to the receiver 20 through the FSO (Free Space Optics) channel, and the receiver 20 receives the transmission optical signal transmitted from the transmitter 10 as a reception optical signal.

The receiver 20 includes a local oscillator (LO) 21 and a balanced photo detector 22.

The local oscillator 21 generates a local optical signal of a specified frequency. Similar to the light source 11 of the transmitter 10, the local oscillator 21 may also generate and emit light in continuous wave mode. Here, in particular, in the receiver 20 of the embodiment, the local oscillator 21 generates a local optical signal having a frequency difference of half the Baud rate from the transmission frequency generated by the light source 11 of the transmitter 10. That is, in a system where the sampling frequency of the receiver 20 matches the baud rate, the local oscillator 21 generates and outputs a local optical signal with a center frequency that is offset by a frequency difference equal to half the baud rate from the center frequency of the transmission optical signal, i.e., a Minimum Nyquist frequency (MNF), which is a frequency corresponding to half-band (β/2) of the available bandwidth (β).

The local optical signal generated from the local oscillator 21 and the reception optical signal are beat to generate a beating optical signal, which is then applied to the balanced photo detector 22. The balanced photo detector 22 receives the beating optical signal, which is generated by beating the reception optical signal and the local optical signal, to acquire a reception signal. The balanced photo detector 22 may be composed of two photo detectors 23 and 24, each of which detects the intensity of the received optical signal.

Although not shown for convenience, the balanced optical photo 22 may further include a first optical coupler (not shown) for combining and beating the local optical signal and the reception signal, and a second optical coupler (not shown) for splitting the beating optical signal into two optical signals and applying them to the two photo detectors 23 and 24 of the balanced photo detector 22. Here, the balanced photo detector 22 may detect the intensity difference between the first beating optical signal, according to the sum of the reception optical signal and the local optical signal, and the second beating optical signal, according to the difference between the reception optical signal and the local optical signal, and output it as the reception signal.

The two photo detectors 23 and 24 of the balanced photo detector 22 each receive one of the two beating optical signals distributed from the second optical coupler, detect the intensity, and acquire a signal with an intensity according to the difference between the optical intensities detected by the two photo detectors 23 and 24 as a reception signal. Here, the transmission optical signal was generated by modulating the I signal and the Q signal using the OQAM technique, which has a delay time difference of ½ (t₀/2) of the symbol period (t₀), which is the offset time, so the reception signal contains the I component and Q component of the symbol alternately. Accordingly, the generated reception signal is then converted into a digital signal by an Analog-Digital Converter (hereinafter, ADC) (not shown) or the like, and digital signal processed by a digital signal processing module (not shown) so that the I component and Q component of the symbol may be distinguished and output.

That is, in one embodiment, by having a local oscillator 21 generate a local optical signal having a frequency difference equal to the minimum Nyquist frequency (MNF) from the center frequency of the transmission optical signal, and beating the generated local optical signal and the reception optical signal, the receiver 20 can obtain a reception signal capable of detecting both the I component and the Q component with a single balanced photo detector. In this way, the technique of detecting a reception optical signal by generating a local optical signal having a frequency difference equal to the minimum Nyquist frequency (MNF) within the bandwidth (β) from the center frequency of the transmission optical signal by the receiver 20 is referred to herein as the Nyquist Intradyne Detection technique.

In existing coherent communication systems, Homodyne Detection and Heterodyne Detection methods have been primarily used. In the homodyne detection method, a local oscillator generates a local optical signal with the same center frequency as the transmission optical signal. Then, the reception optical signal and the local optical signal are each split into two optical signals, which are then crossed and beat. The two beating optical signals, in which the reception optical signal and the local optical signal are beat, are applied to two balanced optical detectors, respectively, so that the I signal and the Q signal are distinguished and detected by the two balanced photo detectors. In this homodyne detection method, the center frequency and phase of the local optical signal generated from the local oscillator must match those of the reception optical signal, so not only does it require additional components such as an Optical Phase Locked Loop (OPLL), but it also requires the use of two balanced photo detectors and more optical couplers, which increases the complexity of the structure. Additionally, an unintended 3 dB optical power loss occurs in the process of dividing the reception optical signal and the local optical signal into two optical signals each.

Meanwhile, in the heterodyne detection method, a local oscillator generates a local optical signal having a frequency difference greater than the bandwidth (B) from the center frequency of the transmission optical signal, beats the reception optical signal and the local optical signal, and then detects the optical intensity with a photo detector to obtain an optical intensity signal, and then resynthesizes the obtained optical intensity signal with a local RF signal generated by a separately provided RF-based local oscillator, to obtain a reception signal. This heterodyne detection method has a simple structure because it does not distinguish between the I signal and the Q signal in the process of obtaining the optical intensity signal, but it has the problem of requiring an additional RF-based local oscillator, and also has the problem of an additional 3 dB of optical power loss in the process of synthesizing the optical intensity signal and the local RF signal.

In contrast, the receiver 20 of one embodiment can detect both the I and Q signals with just one balanced photo detector 22, allowing for a simple structure. Furthermore, since the reception optical signal and the local optical signal do not need to be split into two optical signals each, and do not need to be converted to RF signals, the optical signal power loss and bit error rate can be reduced.

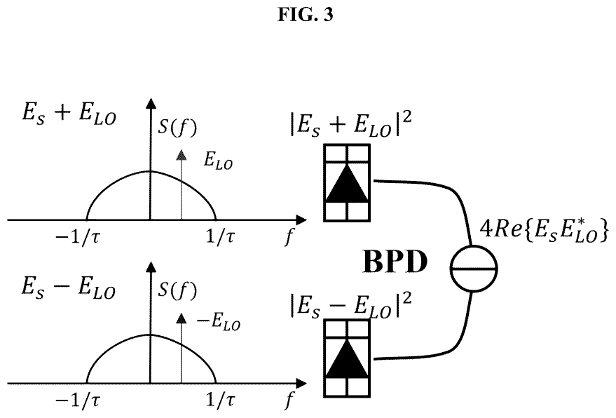

FIG. 3 is a drawing for explaining a signal detected by the balance optical detector of FIG. 1.

Hereinafter, a method by which a receiver 20 detects I and Q signals from a reception optical signal in a coherent optical communication system according to one embodiment is described in detail. First, light having intensity E₀ in the E-field output from the light source 11 is split into two split lights each with intensity

$$\frac{{E}_{0}}{\sqrt{2}}$$

by the first optical coupler, and the two split lights are applied to each of the first and second modulation modules of the transmitter 10. Then, when the I and Q components of the n-th symbol are denoted as aₙ and bₙ, respectively, and neglecting the delay time caused by the delay unit 16, the first and second modulators 13 and 14 each intensity-modulate the applied split light and output the same. The optical signal modulated by the second modulator 14 is phase-shifted by π/2 by the phase controller 15. Accordingly, the transmission optical signal, which is a combination of the optical signals output from the first and second modulation modules, respectively, is output as a complex number format signal in which the real component aₙ and the imaginary component bₙ are combined.

However, in one embodiment, a delay unit 16 is further provided in the second modulation module, so that the split optical signal is delayed by half (t₀/2) of the symbol period (t₀) in the second modulation module and is input to the second modulator 14 and modulated. Therefore, as illustrated in the lower portion of (a) of FIG. 2, in the n-th symbol interval (0 to t₀ in FIG. 2), the transmission optical signal in the ½ symbol interval (0 to t₀/2) is output by combining the I component (Iₙ) of the current symbol and the Q component (bₙ₋₁) of the previous symbol, and the transmission optical signal in the remaining ½ symbol interval (t₀/2 to t₀) is output by combining the I component (Iₙ) and Q component (bₙ) of the current symbol.

That is, the transmitter 10 divides one symbol interval into ½ symbol intervals and transmits different transmission optical signals for each ½ symbol interval.

Meanwhile, when the reception optical signal Es received by the receiver 20 and the local optical signal E_{LO} generated by the local oscillator 21 of the receiver 20 are beat, two beating optical signals (Eₒᵤₜ₁, Eₒᵤₜ₂) as in Equation 1 are applied to the two photo detectors 23 and 24 of the balanced photo detector 22, respectively.

$${E}_{out 1} = \frac{{E}_{s} {e}^{j {ω}_{carrier} t} + {E}_{LO} {e}^{j {ω}_{LO} t} {e}^{j ϕ}}{2} \qquad [ Equation 1 ]$$

$${E}_{out 2} = \frac{{E}_{s} {e}^{j {ω}_{carrier} t} - {E}_{LO} {e}^{j {ω}_{LO} t} {e}^{j ϕ}}{2}$$

Here, Eₛ is the reception optical signal, E_{LO} is the local optical signal, ω_{carrier} is the optical angular frequency (2πf_{carrier}, where f_{carrier} is, for example, about 193 THz) of the reception optical signal (Eₛ), ω_{LO} is the optical angular frequency of the local optical signal, and ø represents the relative phase of the local optical signal.

Since the photo detectors 23 and 24 of the balanced photo detector 22 can only detect the intensity of the applied optical signal, the intensity signals (Iₒᵤₜ₁, Iₒᵤₜ₂) detected by the two photo detectors 23 and 24 can be obtained as in Equation 2.

$${I}_{out 1} = {\vert {E}_{out 1} \vert}^{2} = {E}_{out 1} {E}_{out 1}^{*} = \frac{1}{4} ( {\vert {E}_{s} \vert}^{2} + {E}_{LO}^{2} + 2 Re \{ {E}_{s} {E}_{LO} {e}^{j ( ( {ω}_{carrier} - {ω}_{LO} ) t - ϕ )} \} ) \qquad [ Equation 2 ]$$

$${I}_{out 2} = {\vert {E}_{out 2} \vert}^{2} = {E}_{out 2} {E}_{out 2}^{*} = \frac{1}{4} ( {\vert {E}_{s} \vert}^{2} + {E}_{LO}^{2} - 2 Re \{ {E}_{s} {E}_{LO} {e}^{j ( ( {ω}_{carrier} - {ω}_{LO} ) t - ϕ )} \} )$$

Here,

$${E}_{out 1}^{*} and {E}_{out 2}^{*}$$

represent un conjugate transpose of the beating optical signals (Eₒᵤₜ₁, Eₒᵤₜ₂), respectively.

In addition, as described above, the balanced photo detector 22 outputs the difference between the intensity signals (Iₒᵤₜ₁, Iₒᵤₜ₂) detected by the two photo detectors 23 and 24, so the reception signal (signal) is obtained by Equation 3.

$$Signal = {I}_{out 1} - {I}_{out 2} = Re \{ {E}_{s} {E}_{LO} {e}^{j ( ( {ω}_{carrier} - {ω}_{LO} ) t - ϕ )} \} \qquad [ Equation 3 ]$$

In the case of an optical communication system using a homodyne detection technique, since the optical angular frequency (ω_{carrier}) of the reception optical signal (Eₛ) and the optical angular frequency (ω_{LO}) of the local optical signal (E_{LO}) are identical (ω_{carrier}=ω_{LO}), under the assumption that the relative phase (ø) of the local optical signal is 0 (ø=0), the reception signal (signal) is obtained as RE{EₛE_{LO}} from Equation 3.

Meanwhile, the reception optical signal (Eₛ) is a complex number format signal including a real component (a(t)) corresponding to the I component and an imaginary component (b(t)) corresponding to the Q component during I/Q modulation, and can be defined as in Equation 4.

$${E}_{s} = a ( t ) + ib ( t ) \qquad [ Equation 4 ]$$

Since the local optical signal (E_{LO}) is a real component, the reception signal (signal) obtained as RE{EₛE_{LO}} is obtained as a(t). Here, when the relative phase (ø) of the local optical signal output from the local oscillator 21 is adjusted to π/2 (ø=π/2), the reception signal (signal) detected by the balanced photo detector 22 becomes RE{−iEₛE_{LO}} and is obtained as b(t).

Therefore, in an optical communication system using a homodyne detection technique, the reception optical signal and the local optical signal must be split so that the relative phase (ø) of the local optical signal (E_{LO}) is adjusted to π/2 (ø=π/2), and the phase of one of the split local optical signals must be adjusted by delaying it by π/2 and then detected by two balanced photo detectors.

In contrast, in the receiver 20 of one embodiment, the optical angular frequency (ω_{carrier}) of the reception optical signal (Eₛ) and the optical angular frequency (ω_{LO}) of the local optical signal (E_{LO}) do not match (ω_{carrier}≠ω_{LO}). Therefore, assuming there is no phase error and the relative phase (ø) is 0 (ø=0), the reception signal (signal) in Equation 3 can be expressed as Equation 5.

$$signal = {I}_{out 1} - {I}_{out 2} = Re \{ {E}_{s} {E}_{LO} {e}^{j ( ( {ω}_{carrier} - {ω}_{LO} ) t )} \} \qquad [ Equation 5 ]$$

In particular, in the receiver 20 of one embodiment, since the local oscillator 21 generates a local optical signal (E_{LO}) having a frequency difference equal to the minimum Nyquist frequency (MNF) compared to the reception optical signal (Eₛ), the Nyquist angular frequency (ω_{MNF}) representing the difference between the optical angular frequency (ω_{carrier}) of the reception optical signal (Eₛ) and the optical angular frequency (ω_{LO}) of the local optical signal (E_{LO}) in Equation 5 can be expressed as ω_{carrier}−ω_{LO}=−ω_{MNF}.

Therefore, the reception signal of Equation 5 is rearranged as in Equation 6.

$${I}_{out 1} - {I}_{out 2} = Re \{ {E}_{s} {E}_{LO} {e}^{- j {ω}_{MNF} t} \} = Re \{ {E}_{LO} ( a ( t ) + ib ( t ) ) {e}^{- j {ω}_{MNF} t} \} \qquad [ Equation 6 ]$$

Meanwhile, since it can be expressed as e^{-jω}^{_{MNF}}^{t}=cos(ω_{MNF}t)−i sin(ω_{MNF}t) due to Euler's formula, if substituting this into Equation 6, Equation 7 can be obtained.

$$\begin{matrix}{I}_{out 1} - {I}_{out 2} = Re \{ {E}_{LO} ( a ( t ) + ib ( t ) ) ( cos ( {ω}_{MNF} t ) - i sin ( {ω}_{MNF} t ) ) \} \\ = {E}_{LO} ( a ( t ) cos ( {ω}_{MNF} t ) + b ( t ) sin ( {ω}_{MNF} t ) )\end{matrix} \qquad [ Equation 7 ]$$

Meanwhile, as shown in (a) of FIG. 2, assuming that the transmitter 10 transmits a transmission optical signal of a BPSK (Binary Phase Shift Keying) modulated square wave waveform in the I-axis and Q-axis directions within a limited bandwidth (β), the local oscillator 21 generates a local optical signal having a frequency difference equal to the minimum Nyquist frequency (f_{MNF}) corresponding to β/2, as shown in (b) of FIG. 2. Therefore, one period of the local optical signal (E_{LO}) corresponds to two periods of the reception optical signal (Eₛ). That is, one cycle of the local optical signal (E_{LO}) corresponds to two symbol intervals (0 to 2t₀) of the reception optical signal (Eₛ). Therefore, during one cycle of the local optical signal (E_{LO}), the phase (ω_{MNF}t) of the reception signal, determined by the Nyquist angular frequency (ω_{MNF}) and time (t), varies from 0 to 2π. In addition, the receiver 20 of one embodiment may be configured to detect the reception signal (signal) when the phase (ω_{MNF}t) of the reception signal is 0, π/2, π, and 3π/2, respectively. That is, the reception signal can be detected four times during one cycle of the local optical signal (E_{LO}).

From Equation 7, when the phase (ω_{MNF}t) of the reception signal is 0, cos(ω_{MNF}t) is 1 and sin(ω_{MNF}t) is 0, so a(t) is detected, and when the phase (ω_{MNF}t) is π/2, cos(ω_{MNF}t) is 0 and sin(ω_{MNF}t) is 1, so b(t) is detected. Furthermore, when the phase (ω_{MNF}t) is T, cos(ω_{MNF}t) is −1 and sin(ω_{MNF}t) is 0, so −a(t) is detected, and when the phase (ω_{MNF}t) is 3π/2, cos(ω_{MNF}t) is 0 and sin(ω_{MNF}t) is −1, so −b(t) is detected.

That is, during one cycle of the local light signal (E_{LO}), the reception signal (signal) can be detected as a(t), b(t), −a(t), −b(t), and it can be seen that the I/Q signals are detected as I, Q, −I, −Q. Accordingly, the receiver 20 can detect the value of the reception signal when the phase (ω_{MNF}t) is 0, π/2, π, and 3π/2 through digital signal processing from the reception signal converted into digital data by the ADC (not shown), thereby obtaining the I/Q components of the symbol, respectively. Here, since the −I and −Q values are detected when the phase (ω_{MNF}t) is π and 3π/2, the digital signal processing module may sign-invert the detected −I and −Q values to obtain the I and Q values.

Consequently, in a coherent optical communication system according to one embodiment, the transmitter 10 generates a transmission optical signal by synthesizing I/Q signals modulated to have an offset time difference equal to half the symbol period. In addition, the receiver 20 generates a local optical signal having a frequency difference equal to the Nyquist frequency from the transmission optical signal, beats it with the reception optical signal, and detects the beating optical signal with a single balanced photo detector to obtain a reception signal. Therefore, the receiver does not need to split the reception optical signal and the local optical signal, thereby suppressing 3 dB power loss. Furthermore, the reception signal can be detected with a single balanced photo detector. Therefore, it is possible to detect optical signals transmitted at high transmission rates with low complexity and bit error rate.

In the illustrated embodiment, respective configurations may have different functions and capabilities in addition to those described above, and may include additional configurations in addition to those described above. In addition, in an embodiment, each configuration may be implemented using one or more physically separated devices, or may be implemented by one or more processors or a combination of one or more processors and software, and may not be clearly distinguished in specific operations unlike the illustrated example.

In addition, the coherent optical communication system shown in FIG. 1 may be implemented in a logic circuit by hardware, firm ware, software, or a combination thereof or may be implemented using a general purpose or special purpose computer. The apparatus may be implemented using hardwired device, field programmable gate array (FPGA) or application specific integrated circuit (ASIC). Further, the apparatus may be implemented by a system on chip (SoC) including one or more processors and a controller.

In addition, the coherent optical communication system may be mounted in a computing device or server provided with a hardware element as a software, a hardware, or a combination thereof. The computing device or server may refer to various devices including all or some of a communication device for communicating with various devices and wired/wireless communication networks such as a communication modem, a memory which stores data for executing programs, and a microprocessor which executes programs to perform operations and commands.

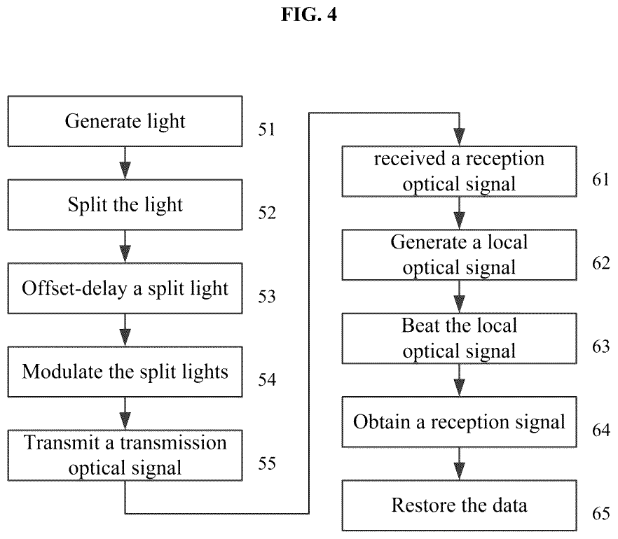

FIG. 4 illustrates a transmitting and receiving method of a coherent optical communication system according to one embodiment.

Referring to FIG. 4, the transmitting and receiving method of the coherent optical communication system of one embodiment is largely divided into a transmission step and a reception step.

In the transmission step, light of a specified frequency is first generated (51). Then, the generated light is split into two (52). Once the generated light is split into two, one of the two split lights is delayed by a specified offset time (53). Here, the offset time may be half the symbol period (t₀/2) depending on the modulation method. Then, the split light and the light delayed by the offset time are modulated according to each of the I and Q components of the symbol obtained by precoding the data, thereby obtaining the I and Q signals (54). Here, the light modulation may be intensity modulation using a MZM, etc. Furthermore, the light modulated according to the Q component may be phase-delayed by an additional 90 degrees (π/2) to obtain a Q signal. Once the I and Q signals are obtained, the obtained I and Q signals are combined to generate a transmission optical signal, which is then transmitted to the receiver 20 (55).

As a result, the transmitter 10 performs optical modulation using the Offset-QAM technique to obtain a transmission optical signal.

In the reception step, the transmission optical signal transmitted from the transmitter 10 is received as a reception optical signal (61). Then, a local oscillator 21 generates a local optical signal (62). Here, the local optical signal, generated from the light source 11 of the transmitter 10, has a center frequency that is offset by a frequency difference equal to half the baud rate, i.e., the minimum Nyquist frequency, from the frequency of the transmission optical signal.

Once the local optical signal is generated, the reception optical signal (Eₛ) and the local optical signal (E_{LO}) are beat to obtain a beating optical signal (63). Then, the beating optical signal is detected by a balanced photo detector to obtain a reception signal (signal) (64). Due to the frequency difference between the reception optical signal (Eₛ) and the local optical signal (E_{LO}), the reception signal (signal) varies according to the Nyquist angular frequency (ω_{MNF}), which represents the difference between the optical angular frequency (@LO) of the local optical signal (E_{LO}) and the optical angular frequency (ω_{carrier}) of the reception optical signal (Eₛ). Accordingly, from the reception signal obtained when the phase (ω_{MNF}t) of the reception signal (signal) determined by the Nyquist angular frequency (@MNF) and time (t) is 0, π/2, π, and 3π/2, the I and Q components of consecutive symbols are alternately detected, and the data transmitted by the transmitter 10 is restored from the detected I and Q components (65). Here, when the phase (ω_{MNF}t) of the reception signal (signal) is 0 and π/2, the I and Q values for the first symbol can be obtained as is, but when the phase (ω_{MNF}t) is I and 3π/2, the −I and −Q values are detected, so the I and Q values for the second symbol can be obtained by inverting the signs of the detected −I and −Q values.

In FIG. 4, it is described that respective processes are sequentially executed, which is, however, illustrative, and those skilled in the art may apply various modifications and changes by changing the order illustrated in FIG. 4 or performing one or more processes in parallel or adding another process without departing from the essential gist of the exemplary embodiment of the present disclosure.

The present disclosure has been described in detail through a representative embodiment, but those of ordinary skill in the art to which the art pertains will appreciate that various modifications and other equivalent embodiments are possible from this. Therefore, the true technical protection scope of the present invention should be determined by the technical spirit set forth in the appended scope of claims.

What is claimed is:

1. A coherent optical receiving method comprising the steps of:
receiving a transmission optical signal that is transmitted by being offset QAM modulated so that an I signal and a Q signal from a transmitter have a delay time difference equal to an offset time as a reception optical signal;
generating a local optical signal having a frequency difference within a bandwidth range from the transmission optical signal by a local oscillator;
obtaining a beating optical signal by beating the reception optical signal and the local optical signal;
receiving the beating optical signal by a balanced photo detector to obtain a reception signal; and
restoring data transmitted by the transmitter from the reception signal.

2. The coherent optical receiving method according to claim 1,
wherein the local optical signal is generated to have a frequency difference equal to a minimum Nyquist frequency compared to a frequency of the transmission optical signal.

3. The coherent optical receiving method according to claim 1,
wherein the step of restoring data includes
detecting an intensity of the reception signal when a phase of the reception signal determined by time and Nyquist angular frequency representing the difference between an optical angular frequency of the local optical signal and an optical angular frequency of the reception optical signal is 0, π/2, π, and 3π/2, and obtaining I value and Q value for two consecutive symbols, and restoring data from the obtained I value and Q value.

4. The coherent optical receiving method according to claim 3,
wherein the step of restoring data includes
obtaining the I value and Q value of a first symbol among the two symbols from the detected intensity of the reception signal when the phase of the reception signal is 0 and π/2.

5. The coherent optical receiving method according to claim 3,
wherein the step of restoring data includes
obtaining the I value and Q value of a second symbol among the two symbols by inverting the sign of the detected intensity of the reception signal when the phase of the reception signal is π and 3π/2.

6. The coherent optical receiving method according to claim 1,
wherein the transmission optical signal is generated by
delaying one of two split lights generated and split from a light source by half a time of a symbol period corresponding to the offset time,
modulating an intensity of each of the two split lights according to I component and Q component of a symbol, and then
combining the lights after delaying the phase of the light modulated according to the Q component by π/2.

7. The coherent optical receiving method according to claim 1,
wherein the offset time is set to half a symbol period.

8. A coherent optical receiver including:
a local oscillator for generating a local optical signal having a frequency difference within a bandwidth range from a transmission optical signal transmitted by a transmitter by offset QAM modulating so that an I signal and a Q signal have a delay time difference equal to an offset time;
an optical coupler for obtaining a beating optical signal by beating the local optical signal with a reception optical signal which is the transmission optical signal received; and
a balanced photo detector for obtaining a reception signal by receiving the beating optical signal.

9. The coherent optical receiver according to claim 8,
wherein the local oscillator generates the local optical signal to have a frequency difference equal to a minimum Nyquist frequency compared to a frequency of the transmission optical signal.

10. The coherent optical receiver according to claim 8,
wherein the coherent optical receiver further includes
a digital signal processing module that detects an intensity of the reception signal when the phase of the reception signal determined by time and Nyquist angular frequency representing the difference between an optical angular frequency of the local optical signal and an optical angular frequency of the reception optical signal is 0, π/2, π, and 3π/2, and obtains I value and Q value for two consecutive symbols, and restores data transmitted from the transmitter from the obtained I value and Q value.

11. The coherent optical receiver according to claim 10,
wherein the digital signal processing module
obtains the I value and Q value of a first symbol among the two symbols from the detected intensity of the reception signal when the phase of the reception signal is 0 and π/2.

12. The coherent optical receiver according to claim 10,
wherein the digital signal processing module
obtains the I value and Q value of a second symbol among the two symbols by inverting the sign of the detected intensity of the reception signal when the phase of the reception signal is π and 3π/2.

13. The coherent optical receiver according to claim 8,
wherein the transmission optical signal is generated by
delaying one of the two split lights generated and split from a light source by half a time of a symbol period corresponding to the offset time,
modulating an intensity of each of the two split lights according to I component and Q component of a symbol, and then
combining the lights after delaying the phase of the light modulated according to the Q component by π/2.

14. The coherent optical receiver according to claim 8,
wherein the offset time is set to half a symbol period.
